(19) United States
(12) Patent Application Publication
(10) Pub. No.: US 2011/0114431 A1
(43) Pub. Date: May 19, 2011

(54) Crouse River Rail System

(75) Inventor: Timothy Christian Crouse, Murray, KY (US)

(73) Assignee: Timothy Christian Crouse, Murray, KY (US)

(21) Appl. No.: 12/945,844

(22) Filed: Nov. 13, 2010

Related U.S. Application Data
(60) Provisional application No. 61/281,335, filed on Nov. 13, 2009.

(51) Int. Cl. B60L 9/00

(52) U.S. Cl. 191/2

(57) ABSTRACT

This is a River Rail system which can be used to move barges or any water going vessel through, up, across. or down a body of water whereby the barge or vessel may attach, use the system in some way or benefit during transit, and then de-attaching from the system. This system can upgrade the transport of goods or people by water industries while also providing a method of creating carbon credits, clean electricity, adding safety in transportation, and possibly eliminating 100% of all fuel consumed by the entire water going transport of people or goods industry through any body of water.

### RELATION TO PRIOR APPLICATION

This non-provisional utility patent application is based on and claims the benefit of the prior provisional patent application, U.S. Ser. No. 61/281,335 filed on date Nov. 13, 2009.

### BACKGROUND OF THE INVENTION

### Field of the Invention

This invention ultimately refers to the water based shipping and transportation industries, for example the barge, tugboat, and or towboat shipping methods. The overall fields in which this invention relates, are in the fields of: clean energy production, creating a cleaner environment or environmental quality improvement, increasing safety for a large part of the transportation industry, eliminating fuel consumption, this invention can benefit the fish and wildlife sectors of our ecosystem, etc. This invention is also a method for creating a enormous amount of carbon credits, if the carbon credit industry becomes a valid industry. If this invention may be used as a means to create carbon credits. This invention has the potential to create more carbon credits than any other invention or process currently available.

This invention will update and make very noticeable improvements to the tugboat, towboat, and barge shipping, and or any or all types of water transport industries, by the creation of a River Rail system. For the purpose of explaining this invention, all areas of business which use water going vessels of any kind to ship people or products by water, will be referred to as the barge industry. Also, the term barges, will be used for referring to all types of water going vessels used for the transport of people or goods, such as: ocean ships, tugboats, towboats, barges, subs, etc. Even though tugboats and towboats do not actually hold products, these are the particular vessels that burn the fuel and provide the power to move vessels or barges in their industries. Therefore tugboats and towboats, especially, will be referred to as barges in this application so as not to repeatedly have to redundantly type tugboat and towboat every time both can be used.

This invention can be used in rivers, lakes, and oceans. Though this invention may be used in rivers, lakes, and or oceans, all types or bodies of water where this may be used will be referred to as a river for shortening all descriptions. In no way does the use of the terminology discussed limit the areas of use or the types of shipping industries where this invention may be used.

### DETAILED DESCRIPTION OF THE PREFERRED EMBODIMENT

A River Rail is a organized structure that can aid a barge or any water going vessel for one or any combination of the following reasons or needs: by providing a track of some kind which may be used by the barge where the barge may use the track to get from one point to another for direction control or leverage; and or the River Rail system may provide a organized structure and or system whereby a barge may connect to the system whereby the connection between a barge and the River Rail system allow for a transfer of electricity from either the River Rail system to the barge, and or it may be used to transfer of electricity from the barge to the River Rail system, or both, while in transit through a portion of or all of, a body of water. The River Rail is a organized system of aiding the transit of barges, whereby the barge might freely attach and use for traveling a certain distance up or down a river, lake, or ocean then de-attach and use battery power, engines, or any other method of power and once off the system to travel the remaining distance. Direction control while on the system may be the responsibility of the River Rail System, the barges, or it may be the responsibility of both the River Rail system and the barges.

There can be many different possible designs and types of River Rail structures. For example, FIG. 1 shows a system whereby the barge 701, 702, 703, and 704 have attached to the River Rail system electricity line 700 via connection method 800 so that the River Rail may help in giving and or receiving electricity for use by barge for propulsion or internal climate control or any electricity need by a crew while other parts of the rail system may also interact with parts on the barge for direction control, etc. FIG. 1 shows a electricity measuring device and or converter 5 attached to the barge 701 and 703 which may provide a type of governance or method of keeping track of both electricity used and or electricity created by the barge using the system. FIG. 1 utility box 5 may be the way to calculate carbon credits. Box 5 may be read at toll stations, by bar codes, by computer software, etc. and a form created to provide a knowledgeable account of all electricity use, electricity created and or returned to the grid, etc. Nautical miles and or miles traveled up and down the body of water may also be calculated to determine overall barge and River Rail efficiency per barge by using the combination of GPS position mapping along with the read outs from the Box 5 whereby through calculation or mathematic formula, all travel efficiency can be calculated and measured for overall performance and or efficiency. Box 5 can hold GPS systems, computers with software for all kinds of efficiency calculations along with keeping track of cargo, etc.; Box 5 may also contain electricity converters and or inverters to convert electricity coming from the River Rail system to the usable type of the barge and or for going from the barge to the usable type of the River Rail system, etc.; and or Box 5 may have the capability of keeping track of all electricity measuring criteria and cargo on and or off loads, stops, etc.

Another example of the River Rail in shown in FIG. 4 whereby the River Rail system may be that the River Rail might simply be a underwater grid or track 51 whereby a spiked wheel 40 of some kind may simply extend below the barge via arm 41 or to one or both sides and the use the holes in the grid like track so that the spiked wheels may gain leverage by which to use torque or the spinning of the wheel to push or pull the barge or vessel up and or down a river just as a car might drive on a road. The track and spiked wheel may be a better method of traveling against the currents or up river, while using electric motors and propellers might be better for powering barges down river. If the spiked wheel method is used for travel up river, then the propeller system 43 and electric motor may be used as a water turbine system for generating electricity for the crew quarters in transit; and or for generation of electricity for recharging batteries; and or for generation of clean electricity so to return clean electricity generated to the grid; and or for generation of clean electricity for the purpose of creating carbon credits while in transit to offset cost or to create more income; etc. There are many possibilities for the River Rail system. This patent does not suggest one certain method is better than another, but all the methods of creating and using a River Rail shall be a part of this patent application. The River Rail system may or may not service a need of the all the barges on the river. This means that once the River Rail system is in place, its use may be optional, or only certain types of barges may use the system. It's use may depend on its governance as well.

All the possibilities of methods or types of River Rails are not drawn or discussed in this patent, but this patent shall cover any kind, type, or method of River Rail. One or more types of River Rails may be used together as well creating a multiple use or style or type of use structure. FIG. 4 shows a example of a simple power line 700 may be used with a line connector 800 hanging from it and connecting to barge 705 via barge extension 14, also having a line connector 705 (C) used to connect to the River Rail system at point 801, so that a transfer of electricity may be obtained for use by the barge; and or it can be a place of transfer of electricity from the barge to the River Rail system grid. Electrical pole or frame structure 699 (W), which is anchored 50 by a big concrete block down in the water 22 resting on the river floor 30, can have a part that will adjust automatically to the river water height or depth via part or tube 201 attached to floater 202. The Tube 201 would be simply move up and down the vertical pole within Structure 699 (W), aided by the Floater 202 as the water depth moves. This is not the only way or method of use for adjusting for depth or arranging the River Rail System, but it shows one possibility.

Using the method in FIG. 1 and or FIG. 4, the barge or vessel could be powered by electric motors while the barge or vessel would be guided by GPS or even by computer, motion sensors, lasers, drivers, etc. Due to the overall size of barges, the tops or decks of barges provide a very good place or a platform whereas wind turbines may be affixed in some way to create clean electricity. FIG. 3 shows barge 707 having some of the many options of creating electricity using passing wind or water. Barge 707 is shown containing multiple direction capable wind turbines 102, windmill turbines 101, wave turbine-electric motor propellers 106, and hull turbines 105. This inventions shall not be limited to having any number, type, or method of devices attaching to the barges or the river rail system for the purpose of either providing electricity to the overall system, or for using any vessel or part of the system, or even any structure attached to the River Rail system, for creating electricity. FIG. 3 shows the sides of the barge and hull, to be a place to attach wave or motion turbines which use the passing water and or current to spin the turbines.

The following math will show how this method would have the option of returning more clean electricity back to the grid than the amount of electricity the vessel is consuming; while also increasing the speed of the barges; while also eliminating the need for a tug or towboat; while also eliminating entirely the need to group barges together in ‘tows’ thus increasing overall river transport safety; while also decreasing the breaking distance by such barge vessels by more than 9.9/10 the current distance thus increasing safety once again; and the ‘return’ of clean electricity to the grid would create carbon credits; and while also completely eliminating the entire amount of gas or diesel fuel consumed (if used that particular way) by 100% of the distance that barge travels.

An example of what this system will do in terms of performance in the energy field, is determined by the following example. If every single barge traveling up and down river uses this system while containing at least 10 midsized turbines, and if all those barges return all that clean electricity created by those turbines back to the grid, it would create more than 1000 times the amount of carbon credits created by all other methods of creating carbon credits in the entire World combined. One small to mid sized turbine can create 50 Kilowatts which equals 67 horse power. The smaller towboats, which normally push a tow of roughly 10 barges on average, has 600 horsepower diesel engines which equals 447 kilowatts. The largest towboats, also pushing 10 to 15 barges on average, has 10,500 horsepower motors which equals 7,830 kilowatts. The deck of one single barge in a tow can easily hold over 100 turbines, however just say that one barge holds 10 turbines. With ten small to mid sized wind turbines on one barge deck traveling at a constant speed of around 8 knots, so to make the passing wind create 100% efficiency electricity production with the wind turbines, the ten turbines would guarantee generation of 670 horse power and or 500 kilowatts. That means that a normal tow of 10 barges having only 10 turbines each, would generate 6,700 horse power and or 5,000 kilowatts; or a tow of ten barges having 100 turbines each would generate 67,000 horse power and 50,000 kilowatts. This means that for every towboat currently moving with an average of 10 barges in a tow, more than 100 times the amount of power using to currently power that tow could realistically be created using wind turbines and delivered back to the infrastructure system as clean electricity. Using the current fuel based system that towboats have been using for 100 or more years, they are currently moving at the snails pace of 2 knots on average, it sometimes can take a mile to stop them, while they also waste 1500 to 7000 gallons of fuel per day in towboats diesel fuel; while also costing carbon credits at the same time.

For every barge or tow using this River Rail system, more clean electricity can be produced than the amount electricity that being used to power each vessel. With tens of thousands of vessels moving annually up and down river, just look at how much clean electricity would be created and possibly returned back to the overall grid. Also, with all the fuel saved by the elimination of fuel consumption entirely from the whole barge industry, which is currently on average between 1500 to 7000 gallons of diesel fuel per towboat per day, look at how much fuel would be saved; thus look at how much fuel would not have to be purchase overseas; thus look at how much fuel could be distributed back to the pumps; thus look at the reduction of cost of transportation method by water; etc. Using this system, even if you did not charge to ship actual products inside the barges, each barge would still make money by producing more electricity than it would consume so they could sell that electricity back to the grid while creating carbon credits to sell to manufacturers, use themselves, sell on the carbon credit market, etc.

One possible method generating a income or paying for the construction for this system is to keep track of all carbon credits and sell them, charge a toll for all the barges at various sections, give tax deductions, etc. Actually, the construction of any way to use this system is actually assisted or can be assisted because the system is one water. There are several methods of construction, but because it's on water, the towers can be sunk into place and held with concrete instead of digging, etc. They would be floated out and sunk. Miles of River Rail could be constructed on land and then floated out to the right place. The power lines would then be added later. Thousands of jobs would instantly be created while the overall benefit of the system could be used almost immediately. The conversion of barges would generate jobs. The production of electric motors for barges would generate thousands of jobs as well. Barge companies would not mind paying the toll because they would be saving enormous amounts in fuel costs, while also increasing performance, upgrading their industry, etc. at the same time. A rise in fuel cost in 2008 nearly bankrupted the whole barge industry at one time. This system would increase the profits of all parties involved if pursued correctly.

If properly executed, this invention will have a enormously positive impact on every aspect of business in the whole entire country. All the following industries would possibly be affected by the application of this invention in a very good way: the energy industry, manufacturing industry, coal industry, shipping industry, oil industry, World trade, and more. Some applications of this invention can have the ability to completely eliminate every drop of gasoline, oil, and or fuel of any kind used for the transport of people or goods in the entire river transport or barge industry.

It is no secret that the current river shipping system in America is outdated and consumes too much diesel fuel. The tugboats and towboats of the barge industry get little results for the amount of fuel they consume. The overall performance per amount of fuel consumed is horrible. This invention seeks to change that. The lack of growth and performance of the barge and rail industries over the last several decades has led to a overly rapid expansion of the trucking industry. The performance standards of the barge industry has little changed in over 200 years. The enormous growth and fuel consumption statistics created by the trucking industry has as much to do with the fuel mileage capabilities of semi trucks as it does with the lack of growth by the barge and rail industries. Basically, shipping by truck is easier, and shipping by barge or rail is harder. This invention seeks to improve the performance of the barge industry, and while doing so, some ways of using this invention has the ability to both eliminate all fuel in the barge industry and create a enormous clean electricity while doing so. The accessibilities of the river and rail transports methods need to be improved for both industries to take advantage of any improvements. The widespread layout of American cities does not create the best environment for access to rails and rivers, however, the access will be gained by improvement of performance. When the performance aspect of the river or rail industries can equal or just come close to that of shipping by truck, then trucking companies will actually do the work in building or brokering the shipping sales for the rail and river shipping industries; if the river and rail shipping is less expensive. This invention has the possibilities, with all designs, to greatly increase the performance of the barge industry while lowering cost of per item shipping.

The per item or per pound cost of shipping in the barge industry will be cut in half (by using some of the designs, it will be cut in less than half) due to the application of this invention or technology to the barge industry, and the expense of putting this invention in place in not that expensive. Any design for the implementation of this invention, followed by the application of this invention in the barge industry, will pay for its own development quickly in cost savings; while also having the possibility of dominating the carbon credit market.

The methods discussed, in terms of use, implementation, design, and the configuration of this invention, etc. are not all the ways this invention can be configured, designed, implemented, and or used. This invention can be designed many ways. This invention can be used in many ways. This invention can be implemented in many ways. There are several methods to create carbon credits using this invention. If the desire is to create carbon credits, this invention can create more carbon credits than by any other method in the World. This invention, if used in certain ways with certain possible designs, can eliminate 100% of the diesel fuel and or gasoline consumed by the whole barge industry. However, this invention can be used in some ways where diesel fuel or gasoline can still be used, but even then the fuel consumption can be greatly reduced. This patent covers all designs and or all methods of use for the River Rail System, and it covers all methods of creating carbon credits using this system and or by the vessels using the system. The reason this invention allows for different methods of use and design is because it can cover super large waterways, and the waterways are governed. The governing bodies may want one method to be used for one state or area while others may want another method

FIG. 5 shows another possible method of creating a River Rail system by using pole or frame structures 699 (J) and 699 (M) positioned in the water and anchored by concrete blocks 50 (J) and 50 (M). These structures have overhead pulleys 90 (J) and 90 (M) with cables 700 that move in a continuous system. The Barge 702 is attached so that the cable 700 simply provides a place for the barge 702 to attach to the overhead cable, by a hanging cable 800 attaching at location 801 to barge cable 702 (K). The overhead cable pulley system would then provide total power for movement as it can both move and guide the barge down the River Rail system. The barge 702 is shown having a windmill 101 which could be used to charge batteries, provide power to a compartment housing workers, to return back to a grid via other unseen cable connected to the system, etc.

In all the methods of using the River Rail system, greater control over each individual barge may be gained. This means safety can be increased. Also, in gaining more control of each vessel or barge using the system, plus by being able to apply overwhelming reverse or stopping power using electric motors, leverage, having the weight reduced due to reduction of multiple tows being in tow at the same time and guided by a single towboat or tug, etc., the braking distance can be greatly decreased. Also, by having the ability to greater apply power, and by gaining greater control, the speed of all the vessels can be greatly increased.

To speed up transit by river, especially where the dams are located, a track (not shown) can be created to go around the dams. One way of doing this is by submerging vessels connected to a train track like structure, allowing the barges to enter, then flooding the internal portion of the train car where the barge is floating inside, then running the barge floating inside the vessel from point A to point B around the dam, and then re-entering the water and releasing the barge. This does not have to be the only way, but several ways can be created and used with this system. Also, this type of system may be used to increase the life of dams, while also increasing the speed of water transit. Additionally, if this system is used throughout the river rail and river transit industry, smaller dams can be created for flood control without having to create them based on factors regarding the river transport industry. This would allow for dams to be created for creating electricity only, or for flood control only, while not having to add structures or money consuming portions to aid in barge or river transit.

FIG. 6 shows electric stations 2 and 3, which are stations that monitor and manage all electricity situations and or needs. These stations would be used to manage the River Rail system grid, and or they may be used to connect the River Rail system grid to the overall electric grid. These stations may be used throughout the River Rail system in various locations to support the overall River Rail grid system, as well as the overall electrical grid system so that all can benefit. Of course this is not the only way that this can be used or constructed. This drawing just shows one example of many possibilities.

### BRIEF DESCRIPTION OF THE DRAWINGS

FIG. 1 shows a overhead view of one type of River Rail system with vessels attached and using the system.

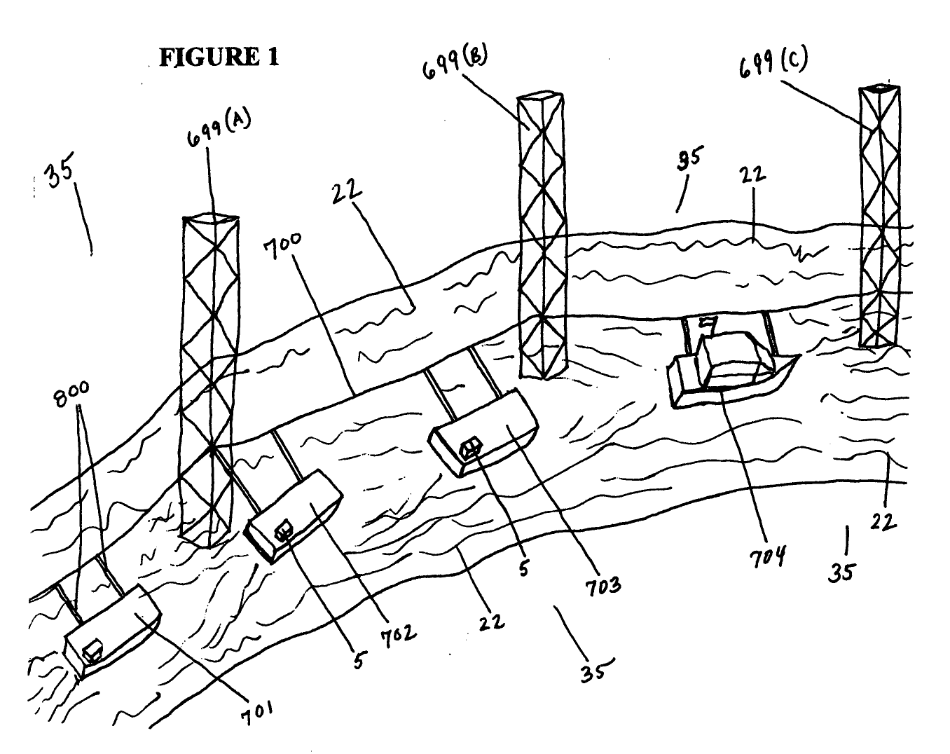

FIG. 2 shows a see through the water side view of a barge connected to a type of River Rail system.

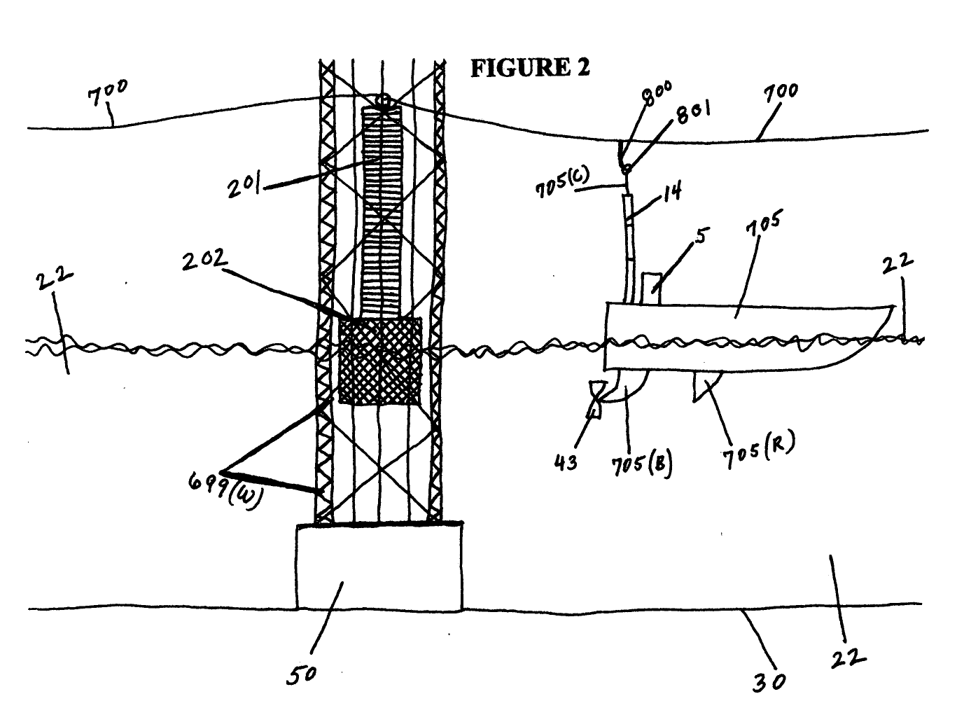

FIG. 3 shows a see through the water side view of a barge having clean electricity creating devices attached or affixed so to have the possibility of creating carbon credits. Part 5 is a electricity converter, inverter, reader, etc. with GPS, computer plus software, etc.

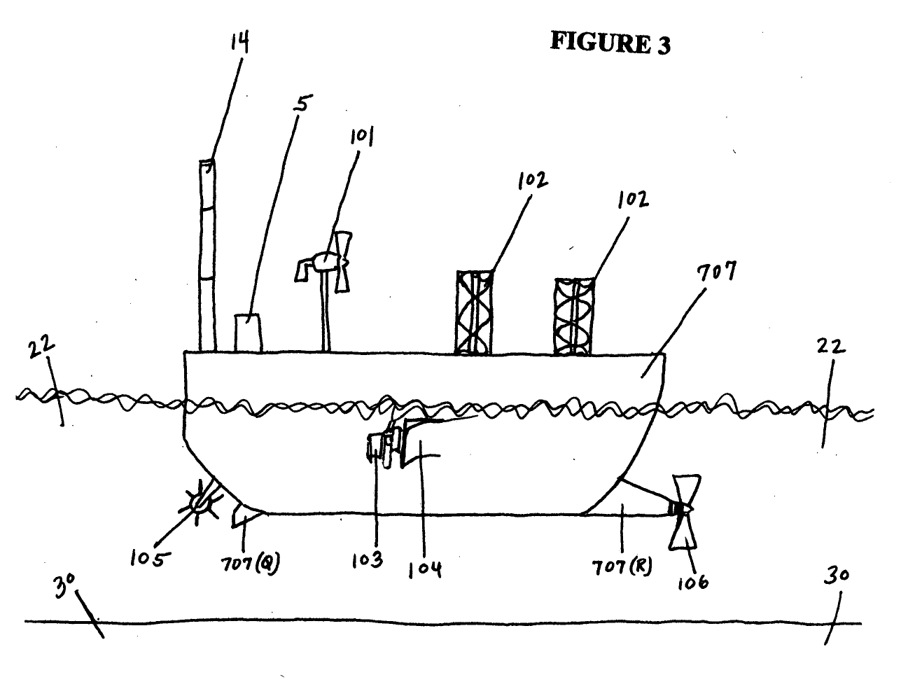

FIG. 4 shows a side see through the water view of one possible method of creating a River Rail made up of a underwater track system.

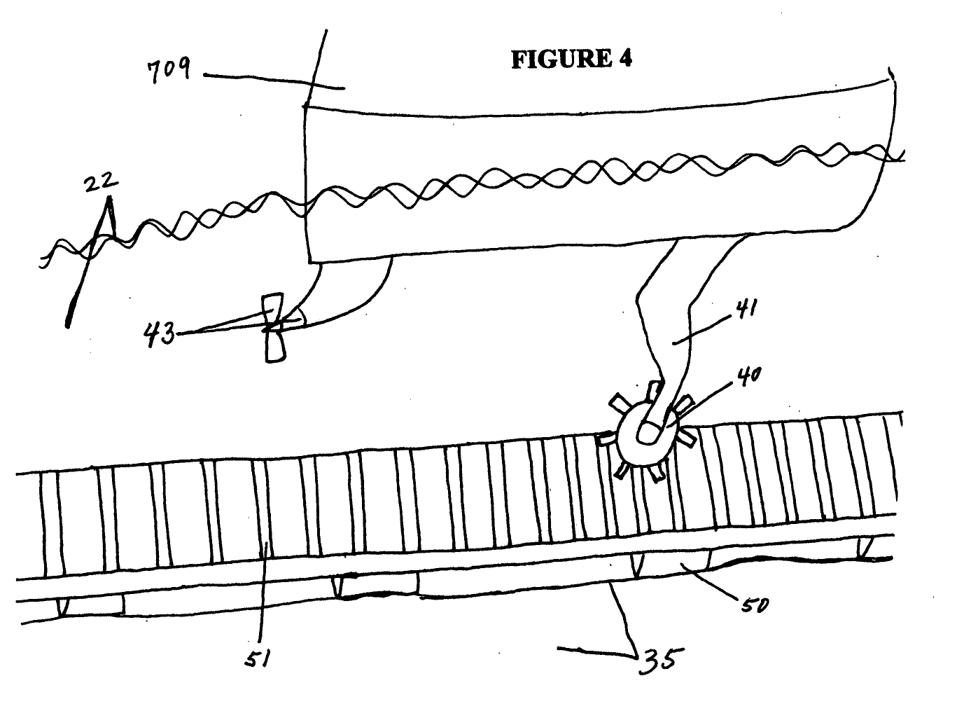

FIG. 5 shows a see through the water side view of a overhead cable pulley River Rail track system with a barge or vessel attached.

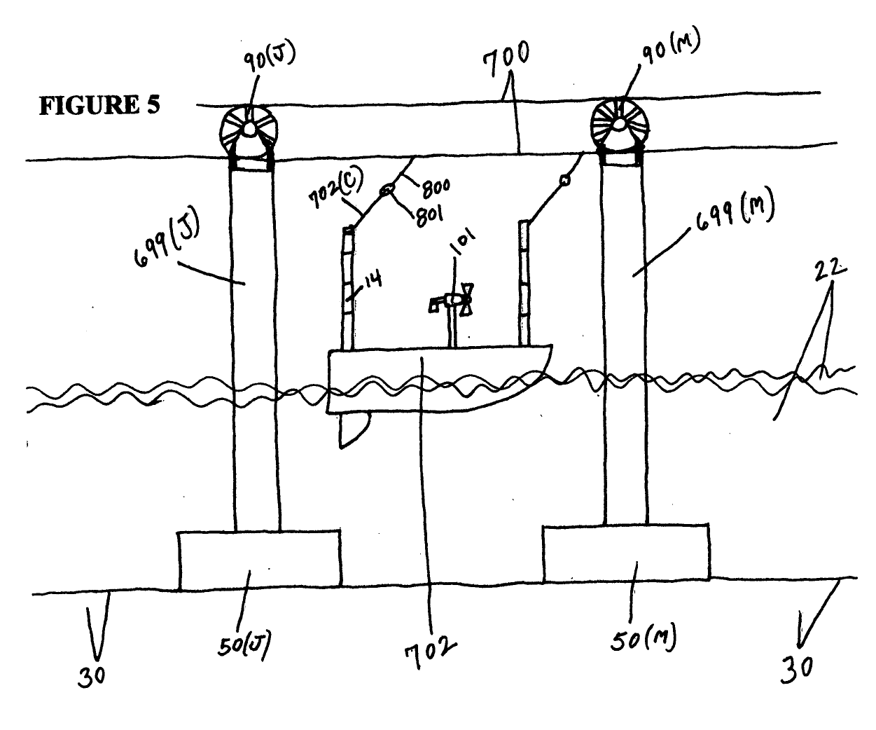

FIG. 6 shows a overhead view of a River Rail system, similar to that in FIG. 1, which also shows electrical bases and or grid management structures out of the water.

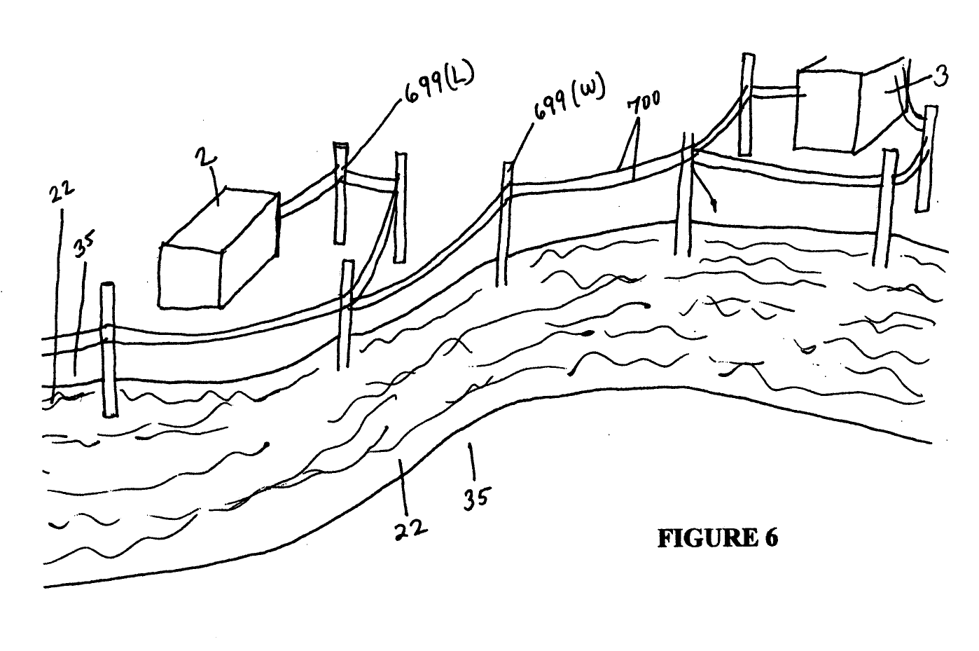

1-4. (canceled)

5. A organized system or structure, having many possible design variations, able to be located or connected at points in or along a river or any body of water, which may also have its own electrical grid or be attached to any outside electric grid at one or more separate locations, and that is capable of connecting in any way to structures on land and or to barges or vessels in the water, for any one of the following reasons;
(a) providing any assistance to the barges or vessels, either physically or electronically attached in any of the following ways: to gain greater control or improve safety, for organization of barge or shipping traffic, to reduce the cost of shipping, to reduce fuel consumption, to reduce greenhouse gasses, to go around dams, etc;
(b) to use the electrically connected structures and or barges or vessels that may be or have attached, devices that can generating electricity, so to generate electricity for use, sale, and or to generate carbon credits or any similar governed or marketed product for use or sale.
(c) using the potential length of the river rail grid and many possible outside grid connection points or electrical links to various separate electric grids along the rail system or body of water, for the purpose of: purchasing, selling, transferring, and or distributing electricity from one area to another to profit off sales and or to generate carbon credits or any similar product if possible. This also includes, with some designs of the river rail, distributing electricity from areas where there is a abundance to areas when there is a outage or shortage; and or less expensive electricity may be purchased from one area then used or sold by the river rail system in another area where it is more expensive; and or less expensive electricity may be purchased in one area and then distributed along the river rail electrical grid to be sold in another area paying more for electricity at a certain time or during a certain season.
